(19) United States
(12) Patent Application Publication
(10) Pub. No.: US 2007/0186257 A1
(43) Pub. Date: Aug. 9, 2007

(54) Set top box, multimedia player and system capable of playing Web TV and method of integrating set top box and multimedia player

(75) Inventors: Cheng-Shing Lai, Taipei (TW); Zheng-Rong Zou, Nanking (CN); Yong-Kang Liu, Nanking (CN)

Correspondence Address: BACON & THOMAS, PLLC, 625 SLATERS LANE, FOURTH FLOOR, ALEXANDRIA, VA, 22314, US

(73) Assignee: Inventec Appliances Corp., Taipei (TW)

(21) Appl. No.: 11/700,116

(22) Filed: Jan. 31, 2007

(30) Foreign Application Priority Data
Feb. 9, 2006 (TW) 095104312

(51) Int. Cl. H04N 7/173

(52) U.S. Cl. 725/109; 725/112; 725/113

(57) ABSTRACT

The present invention discloses a set top box for playing Web TV. The set top box includes a control unit, a network transmission interface, a data transmission interface, and a first interface. The set top box can be connected to a multimedia player through the first interface, such that a multimedia processing unit of the multimedia player can control the control unit and the multimedia processing unit to decode audio/video signals transmitted from the network transmission interface and the data transmitter, and output images and sounds. Therefore, through the multimedia processing unit of the multimedia player, the set top box is able to play Web TV. The invention also discloses a multimedia player, a system capable of playing Web TV, and a method of integrating the set top box and multimedia player for playing Web TV.

### FIELD OF THE INVENTION

The present invention relates to a set top box, a multimedia player, a system capable of playing Web TV, and a method of integrating the set top box and multimedia player, and more particularly to a set top box using a multimedia processing unit of a multimedia player to play Web TV.

### BACKGROUND OF THE INVENTION

As the efficiency of wideband transmissions provided by networks becomes increasingly higher, the feasibility of watching TV and transmitting images through a network is increased, and thus the so-called “Web TV” products becomes popular. The “Web TV” generally has two definitions as follows: One is to use a TV as a terminal display and a built-in (or an external) set top box (STB) to obtain an Internet logon function, and the other one is to use a computer as a terminal display and a wideband network environment including ADSL or cable modem to obtain TV program service function. For simplicity, the former refers to “Watching TV over a network” and emphasizes on a hardware terminal system product, which is called Web TV receiver (Internet STB or WebTV); and the latter refers to “Watching TV program through a network” and emphasizes on TV program content services.

With the concept of the Internet STB, a large quantity of related services and products are introduced to the market, since the global information network is well developed, and Internet service providers (ISP) start providing a large quantity of related services and products. In addition to using a computer as a medium for logging on a network by consumers at home, such medium can be extended to other home appliances (which comes from the concept of “Information Appliance”), and the television in a living room becomes the best choice. In recent years, information or home appliance manufacturers including Microsoft, Sun, Thomson CE, Philips, and SONY, etc invest tremendous manpower and a great deal of capitals to research and develop Internet STB.

However, the cost of the set top box for playing Web TV is relatively high, and the products of this sort cannot promote the Web TV related products due to their high price, so that the rate of using Web TV cannot have a breakthrough. Therefore, many manufacturers in the related industry spare no effort to find solutions for lowering the cost. If the components in the set top box for playing Web TV can be reduced or the components in the set top box for playing Web TV can be integrated with the same components of other products, the cost of the set top box for playing Web TV will be lowered and the market competitiveness will be enhanced. Therefore, finding a way of developing a set top box, a multimedia player, and a system for playing Web TV and a method for integrating the set top box and the multimedia player becomes an important subject for the manufacturers in this industry.

### SUMMARY OF THE INVENTION

In view of the foregoing shortcomings of the prior art, the inventor of the present invention based on years of experience to conduct extensive researches and experiments, and finally developed a set top box, a multimedia player, a system for playing Web TV and a method for integrating the set top box and the multimedia player, in hope of contributing the innovative idea to people.

It is a aspect of the present invention to provide a set top box for playing Web TV, and the set top box comprises a control unit, a network transmission interface, a data transmission interface and a first interface. The first interface can be connected externally to a multimedia player, such that when the multimedia player is connected to different modules of the set top box, a multimedia processing unit of the multimedia player can control the control unit and the multimedia processing unit can decode an audio/video signal transmitted separately from the network transmission interface and the data transmitter and output an image and a sound. Therefore, the set top box only shares the multimedia processing unit with the multimedia player when it is in use, so as to save the cost of components.

Another aspect of the present invention is to provide a multimedia player for playing Web TV, and the multimedia player comprising a casing, a second interface and a multimedia processing unit. The second interface is installed on the casing, and the second interface is coupled externally to a set top box. The multimedia processing unit is installed in the casing and coupled to the second interface, such that the second interface is coupled to components in the set top box for receiving at least one network audio/video data and decoding the data, and outputting at least one video signal and audio signal respectively. Therefore, the multimedia player can share the multimedia processing unit with the set top box to save the cost of components.

A further aspect of the present invention is to provide a set top box system for playing Web TV, and the system comprises a set top box and a multimedia player. The set top box comprises a first interface, a network transmission interface and a control unit. The multimedia player comprises a second interface and a multimedia processing unit. When the multimedia processing unit is coupled to the first interface and second interface, the multimedia processing unit can be coupled to the control unit, the network transmission interface and the data transmission interface for decoding data and outputting at least one video signal and audio signal. Therefore, the set top box system can share the multimedia processing unit when it is in use, so as to save the cost of components.

A further aspect of the present invention is to provide a method for playing Web TV by a set top box system, and the set top box system comprises a set top box and a multimedia player. The set top box comprises a first interface, a network transmission interface and a control unit. The multimedia player comprises a second interface and a multimedia processing unit. The set top box can connect the first interface with the second interface to communicate with the multimedia player. After the set top box system determines that the first interface is connected to the second interface, the control unit sends at least one network audio/video data transmitted from the network transmission interface to the multimedia processing unit, and converts at least one network audio/video data into a video signal and an audio signal, and outputs the signals from the multimedia player.

The aspects, technical characteristics and function of the present invention will become apparent in the following detailed description of the preferred embodiments with reference to the accompanying drawings.

### BRIEF DESCRIPTION OF THE DRAWINGS

FIG. 1 is a schematic view of the present invention;

FIG. 2 is a flow chart of the present invention;

FIG. 3 is a flow chart of a preferred embodiment of the present invention;

FIG. 4 is a flow chart of executing the Web TV function program of the present invention;

FIG. 5 is a flow chart of executing the multimedia playing function program of the present invention;

FIG. 6 is a flow chart of executing the video-recording function program of the present invention; and

FIG. 7 is a flow chart of another preferred embodiment of the present invention.

### DETAILED DESCRIPTION OF THE PREFERRED EMBODIMENTS

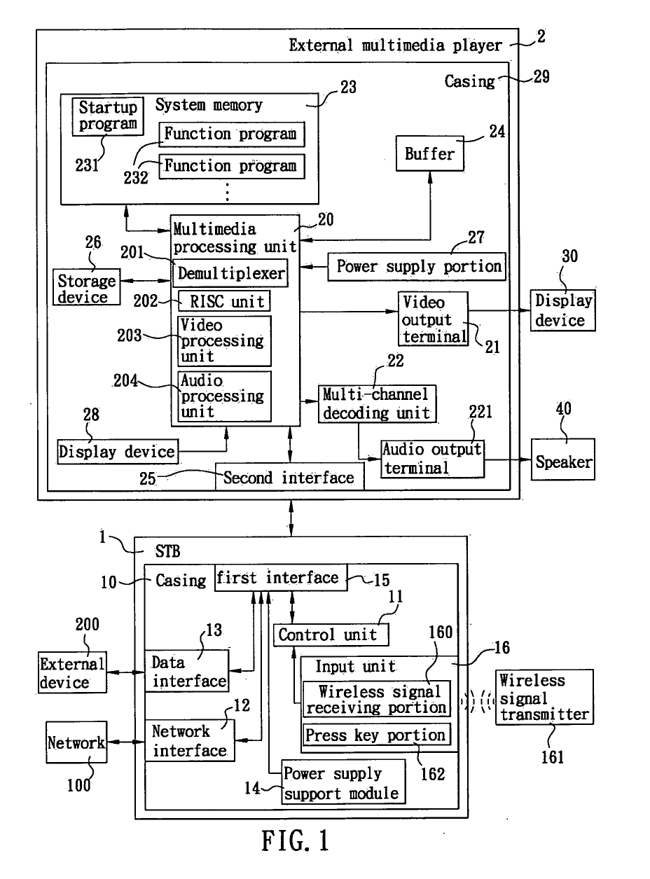

Referring to FIG. 1 for a set top box and a multimedia player for playing Web TV in accordance with a preferred embodiment of the present invention, the set top box 1 comprises a casing 10, and the casing 10 contains a control unit 11 (such as an 8051 MCU) and a power supply support module 14; a network transmission interface 12 (such as an Ethernet network card or a wireless network card) disposed on a surface of the casing 10; a data transmission interface 13 (such as a USB2.0 Host), and a first interface 15 (such as a Mini PCI). The first interface 15 is coupled to the control unit 11, the network transmission interface 12, the data transmission interface 13 and the power supply support module 14. The power supply support module 14 supplies an operating power required by all components of the set top box 1. The first interface 15 externally connects a multimedia player 2 such as a personal multimedia player (PMP), and further connects to a multimedia processing unit 20 in the multimedia player 2, so that the multimedia processing unit 20 can be coupled to the control unit 11, the network transmission interface 12 and the data transmission interface 13 for receiving a plurality of network audio/video data through the network transmission interface 12 connected to a network 100 and an audio/video signal received by an external device 200 (such as a MP3 player) coupled to the data transmitter for decoding data to output a video signal and an audio signal through the set top box 1 or the multimedia player 2. Therefore, the set top box 1 only shares the multimedia processing unit 20 when the set top box 1 is in use, so as to save the cost of components.

In FIG. 1, the set top box 1 further comprises an input unit 16 installed on a surface of the casing 10, and the input unit 16 comprises a press key portion 162 and a wireless signal receiving portion 160. The input unit 16 is coupled to the control unit 11 and triggered to produce an execution instruction. The execution instruction is sent to the control unit 11, and then sent from the control unit 11 to the multimedia processing unit 20 through the first interface 15. The wireless signal receiving portion 160 (such as a RF receiver) receives a radio signal sent from a wireless signal transmitter 161, and the control unit 11 decodes the radio signal to produce the execution instruction. The control unit 11 sends the execution instruction to the multimedia processing unit 20 for performing the operation. In FIG. 1, the present invention provides a set top box system for playing Web TV and the set top box system comprises a set top box 1 and a multimedia player 2 (such as a personal multimedia player, PMP). The set top box 1 comprises a casing 10, and the casing 10 comprises a control unit 11 (such as an 8051 MCU), a power supply support module 14, a network transmission interface 12 (such as an Ethernet network card or a wireless network card) disposed on a surface of the casing 10, a data transmission interface 13 (such as a USB2.0 Host), an input unit 16 and a first interface 15 (such as a Mini PCI). The first interface 15 is coupled to the control unit 11, the network transmission interface 12, the data transmission interface 13 and the power supply support module 14, and the input unit 16 is coupled to the control unit 11 and triggered to produce an execution instruction and sent to the control unit 11. The power supply support module 14 supplies an operating power required by all components of the set top box 1. The first interface 15 can be connected externally with the multimedia player 2, so that the multimedia player 2 can be coupled to the control unit 11, the network transmission interface 12 and the data transmission interface 13 for decoding a plurality of network audio/video data received by a network 100 that is connected to the network transmission interface 12 and an audio/video signal received from an external device 200 (such as a MP3 player) that is coupled externally to the data transmitter, and outputting a video signal and an audio signal.

In FIG. 1, the multimedia player 2 of the invention comprises a casing 29, and the casing 29 contains a multimedia processing unit 20, and the casing 29 has a video output terminal 21 (such as a HDTV signal YpbPr, S-terminal S-Video, AV-terminal composite), an audio output terminal 221 (such as an earphone) and a second interface 25 (such as a Mini PCI). The second interface 25 is coupled to the first interface 15 for transmitting the network audio/video data and the audio/video signal, and the multimedia processing unit 20 is coupled to the second interface 25, the video output terminal 21 and the audio output terminal 221. The multimedia processing unit 20 is coupled to the second interface 25, the control unit 11, the network transmission interface 12 and the data transmission interface 13 for decoding the network audio/video data and the audio/video signal and outputting a plurality of video signals and audio signals respectively, and outputting the video signal from a display device 30 connected externally to the video output terminal 21, and the audio output terminal 221 can be connected externally to a speaker 40 for outputting the audio signal.

In FIG. 1, the casing 29 contains a system memory 23 (such as a NOR flash) and a buffer 24 (such as a SDRAM). The system memory 23 is coupled to the multimedia processing unit 20 for storing a startup program 231 and a plurality of function programs 232, and the startup program 231 provides a plurality of options according to the function programs 232, such that the input unit 16 can enter and select an option for an operation of the set top box system. The buffer 24 is coupled to the multimedia processing unit 20, and the multimedia processing unit 20 is provided for executing the startup program 231 and storing the audio/video signal converted from the network audio/video data, and the multimedia processing unit 20 is provided for reading the audio/video signal and performing a data decoding. The multimedia processing unit 20 comprises a built-in demultiplexer (Demux) 201, a reduced instruction computing (RISC) unit 202, a video processing device (VPD) 203 and an audio processing unit (APU) 204. The network transmission interface 12 sends the network audio/video data to the multimedia processing unit 20 through the first interface 15 and the second interface 25, and the multimedia processing unit 20 drives the demultiplexer 201 to convert the network audio/video data into an audio/video signal, and store the audio/video signal in a buffer 24. The audio/video signal is decoded and processed by the reduced instruction set computing unit 202, the video processing device 203 and the audio processing unit 204 to produce a video signal and an audio signal, such that the multimedia processing unit 20 outputs the video signal from the video output terminal 21; and outputs an analog audio signal converted into the audio signal by the multi-channel decoding unit 22 to the audio output terminal 221.

In FIG. 1, the casing 29 further contains a storage device 26, and the storage device 26 is coupled to the multimedia processing unit 20, such that when the network transmission interface 12 is getting a network audio/video data from the network 100, the multimedia processing unit 20 converts the network audio/video data into a video signal and an audio signal, and then the multimedia processing unit 20 outputs the audio/video signal from the video output terminal 21 and the audio output terminal 221 and also converts the network audio/video data received by the network transmission interface 12 and save the converted network audio/video data in the storage device 26, so as to achieve the function of synchronously recording Web TV programs. The multimedia processing unit 20 also can read the audio/video signal stored in the storage device 26 and output the audio/video signal from the video output terminal 21 and the audio output terminal 221.

In FIG. 1, the multimedia player 2 has a built-in power supply portion 27 and a display device 28, and the power supply portion 27 and the display device 28 are coupled to the multimedia processing unit 20. The display device 28 and the audio output terminal 221 can individually output the audio/video signal that is transmitted from the storage device 26; and the power supply portion 27 can supply an operating power required by components in the multimedia player 2, such that the multimedia player 2 can be detached from the set top box 1 and becomes a separate detachable multimedia player. If a user no longer uses the set top box 1 and the user only uses the multimedia player 2 as a standalone device, the multimedia processing unit 20 can be provided for operating and using the multimedia player 2 alone, because the first interface 15 is far away from the second interface 25 and not coupled to the second interface 25, so that the set top box 1 will not idle the multimedia processing unit 20, and the cost of components can be saved.

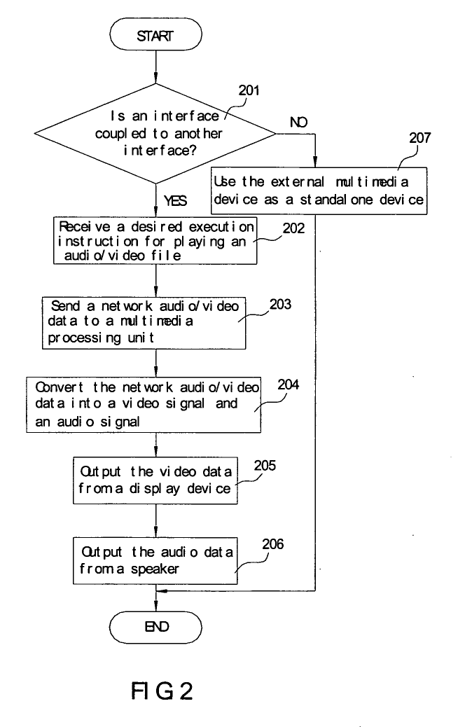

The present invention further provides a method for playing Web TV by a set top box system as shown in FIG. 1, the set top box system comprises a set top box 1 and a multimedia player 2 (such as a personal multimedia player, PMP), and the set top box 1 comprises a first interface 15 (such as a Mini PCI), a network transmission interface 12 (such as an Ethernet network card or a wireless network card), a control unit 11 (such as a 8051 MCU) and an input unit 16 (such as a press key portion 162); and the multimedia player 2 comprises a second interface 25 (such as a Mini PCI) and a multimedia processing unit 20. The set top box 1 can connect the first interface 15 with the second interface 25 for communicating with the multimedia player 2 as shown in FIG. 2, and the set top box system processes a procedure comprising the steps of:

Step (201): determining whether or not the first interface 15 is coupled to the second interface 25; if yes, then go to Step (202); or else go to Step (207);

Step (202): receiving an execution instruction issued by the input unit 16 to play the desired audio/video file;

Step (203): sending a plurality of network audio/video data transmitted from the control unit 11 through the network transmission interface 12 to the multimedia processing unit 20 according to the execution instruction;

Step (204): receiving the audio/video signal and converting the audio/video signal into a video signal and an audio signal;

Step (205): outputting the video signal from a display device 30 through the video output terminal 21;

Step (206): outputting the audio signal from a speaker 40 through the audio output terminal 221; and

Step (207): using the multimedia player 2 as a standalone device.

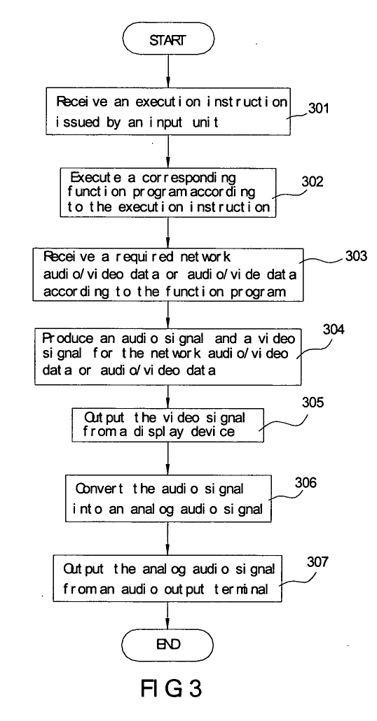

In FIG. 1, the multimedia player 2 of the invention further comprises a system memory 23 for storing a startup program 231 and a plurality of function programs 232. The startup program 231 provides a plurality of options according to the function programs 232, such that the input unit 16 can enter the option to carry out an operation of the set top box system. The function programs 232 may be divided into a Web TV function program, a multimedia playing function program and a video-recording function program. The set top box 1 comprises a data transmission interface 13 coupled to the first interface 15 for externally connecting an external device 200 (such as a MP3 player) and receives a plurality of audio/video signals. The Web TV function program implements the function of viewing a TV screen through a network and uses the function program 232 to connect to a network 100 to view a user's favorable TV channel, and can use an expansion program (Plugin) to expand the functions of the function programs 232 to support more audio/video formats. The network transmission interface 12 is connected externally to the network 100 for receiving a plurality of network audio/video data. The set top box system further comprises a buffer 24 and a multi-channel decoding unit 22 respectively coupled to the multimedia processing unit 20 as shown in FIG. 3. If the multimedia processing unit 20 executes the startup program 231 to start the set top box system, the multimedia processing unit 20 will process a procedure comprising the steps of:

Step (301): receiving an execution instruction issued by the input unit 16;

Step (302): executing the corresponding function program 232 according to the execution instruction;

Step (303): receiving the network audio/video data or audio/video signal through the network transmission interface 12 or the data transmission interface 13 according to the function program 232;

Step (304): decoding the network audio/video data or the audio/video signal to produce a video signal and an audio signal;

Step (305): outputting the video signal from the display device 30 through the video output terminal 21;

Step (306): converting the audio signal into an analog audio signal by the multi-channel decoding unit 22; and

Step (307): outputting the analog audio signal from the audio output terminal 221 through the audio output terminal 221.

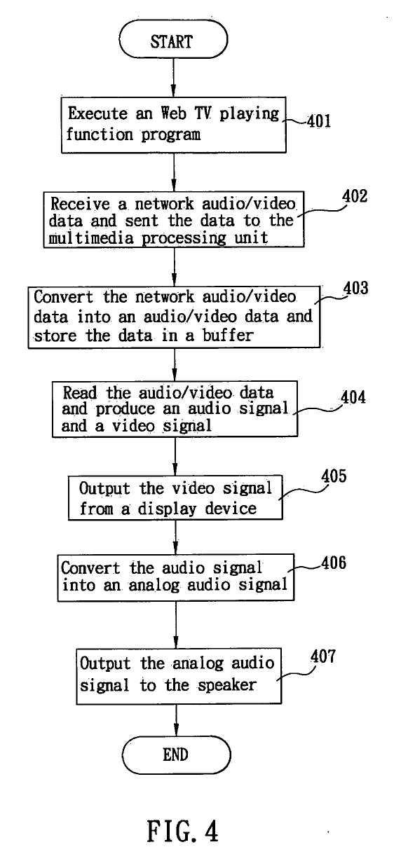

After an option corresponding to a function of the Web TV function program 232 is selected, and the input unit 16 issues a desired execution instruction for playing the Web TV as shown in FIG. 4, the multimedia processing unit 20 processes a procedure comprising the steps of:

Step (401): executing and playing the Web TV function program according to the execution instruction;

Step (402): informing the control unit 11 to receive the network audio/video data through the network transmission interface 12 and return the network audio/video data to the multimedia processing unit 20;

Step (403): converting the network audio/video data into an audio/video signal and store the audio/video signal in the buffer 24;

Step (404): reading the audio/video signal in the buffer 24 and decode the data of the audio/video signal to produce the video signal and audio signal;

Step (405): outputting the video signal from the display device 30 through the video output terminal 21;

Step (406): converting the audio signal into an analog audio signal by the multi-channel decoding unit 22; and

Step (407): outputting the analog audio signal to the speaker 40 through the audio output terminal 221.

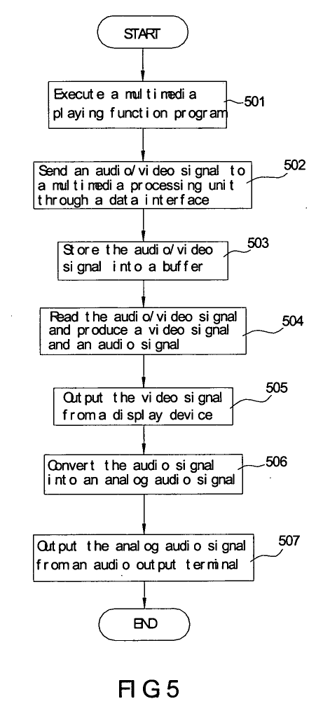

In FIG. 1, the multimedia playing function program can play the audio/video files in the external device 200 and connects a home entertainment device with a network function through a cable or wireless network. After the network is connected, the multimedia messages on the network can be searched automatically. After an option corresponding to a function of the multimedia playing function program is selected, and the input unit 16 issues a desired instruction for executing the multimedia playing function program as shown in FIG. 5, the multimedia processing unit 20 processes a procedure comprising the steps of:

Step (501): executing the multimedia playing function program 232 according to the execution instruction;

Step (502): informing the control unit 11 to drive the data transmission interface 13 to start receiving the audio/video signal and sending the audio/video signal to the multimedia processing unit 20;

Step (503): storing the audio/video signal in the buffer 24;

Step (504): reading the audio/video signal in the buffer 24, and decoding the audio/video signal to produce a video signal and an audio signal;

Step (505): outputting the video signal to the display device 30 through the video output terminal 21;

Step (506): converting the audio signal into an analog audio signal by the multi-channel decoding unit 22; and

Step (507): outputting the analog audio signal from the audio output terminal 221 through the audio output terminal 221.

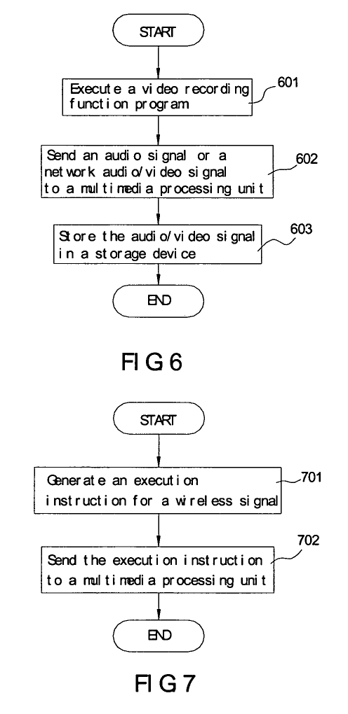

The video-recording function program adopts a storage device 26 as a storage medium as shown in FIG. 1 and stores a plurality of audio/video files composed of the audio/video signals, and its core technologies include digitization and storage technology. The multimedia processing unit 20 can store the processed audio/video signal and network audio/video data transmitted by the external device 200 and network 100 respectively through the multimedia processing unit 20 into the storage device 26, and the storage device 26 is connected to the multimedia processing unit 20 to play the audio/video files. After an option corresponding to a function of the video-recording function program is selected, and the input unit 16 issues the desired instruction for executing the video-recording function program as shown in FIG. 6, the multimedia processing unit 20 processes a procedure comprising the steps of:

Step (601): executing the video-recording function program according to the execution instruction;

Step (602): informing the control unit 11 to send the audio/video signal or the network audio/video data to the multimedia processing unit 20; and

Step (603): storing the audio/video signal in the storage device 26.

In a preferred embodiment of the present invention as shown in FIG. 1, the input unit 16 is a wireless signal receiving portion 160, and the wireless signal receiving portion 160 can receive a radio signal issued by a wireless signal transmitter 161. After the control unit 11 has received a radio signal as shown in FIG. 7, the control unit 11 processes a procedure comprising the steps of:

Step (701): decoding the radio signal and producing an execution instruction; and

Step (702): sending the execution instruction to the multimedia processing unit 20 to command the execution of the corresponding function program 232.

The present invention has been described with a preferred embodiment thereof and it is understood that many changes and modifications in the described embodiment can be carried out without departing from the scope and the spirit of the invention that is intended to be limited only by the appended claims.

What is claimed is:

1. A set top box for playing Web TV, comprising:
a casing;
a network transmission interface, coupled to a network, for receiving at least one network audio/video data from said network;
a first interface, coupled to a multimedia player and said network transmission interface, for sending said network audio/video data to said multimedia player, and using a multimedia processing unit in said multimedia player to process said network audio/video data and outputting said network audio/video data from said set top box or said multimedia player; and
a control unit, coupled to said first interface, for controlling each component in said set top box.

2. The set top box of claim 1, further comprising a data transmission interface coupled to said first interface for receiving at least one audio/video signal from an external device, wherein said audio/video signal is sent to said multimedia processing unit for processing.

3. The set top box of claim 2, further comprising an input unit, disposed on a surface of said casing and coupled to said control unit, such that after said input unit is triggered to produce an execution instruction, said execution instruction is sent to said control unit, and then sent from said control unit to said multimedia processing unit through said first interface.

4. The set top box of claim 3, wherein said input unit comprises a press key portion or a wireless signal receiving portion.

5. The set top box of claim 1, further comprising a power supply support module coupled to said interface for supplying an operating power required by all components of said set top box.

6. A multimedia player capable of playing Web TV, comprising:
a casing;
a second interface, coupled to a set top box;
a multimedia processing unit, coupled to said second interface, for receiving at least one network audio/video data from said set top box and decoding said network audio/video data to output at least one video signal and at least one audio signal.

7. The multimedia player of claim 6, wherein said multimedia processing unit comprises a demultiplexer, a reduced instruction computing unit, a video processing device, and an audio processing unit, wherein said demultiplexer converts at least one network audio/video data into at least one audio/video signal; and at least one of said audio/video signals is decoded and processed by said reduced instruction set computing unit, said video processing device, and said audio processing unit, and then converted into at least one video signal and at least one audio signal.

8. The multimedia player of claim 6, further comprising:
a video output terminal, installed on said casing and coupled to said multimedia processing unit, for outputting at least one of said video signals to a display device;
a multi-channel decoding unit, coupled to said multimedia processing unit, and said multimedia processing unit converting at least one of said audio signals into at least one of said analog audio signal through said multi-channel decoding unit; and
an audio output terminal, installed on said casing and coupled to said multi-channel decoding unit, for converting at least one of said analog audio signals to a speaker.

9. The multimedia player of claim 7, further comprising:
a storage device, coupled to said multimedia processing unit, for storing at least one of said audio/video signals, and said multimedia processing unit being used for reading at least one of said audio/video signals, and outputting at least one of said audio/video signals from said video output terminal and said audio output terminal;
a system memory, coupled to said multimedia processing unit, for storing a startup program to execute the operation of said multimedia player; and
a buffer, coupled to said multimedia processing unit, for executing said startup program and storing at least one of said audio/video signals converted from at least one of said network audio/video data, and said buffer being provided for said multimedia processing unit to read at least one of said audio/video signals for performing a data decoding.

10. The multimedia player of claim 6, further comprising a power supply portion coupled to said multimedia processing unit for supplying an operating power required by all components of said multimedia player.

11. A set top box system capable of playing Web TV, comprising a set top box and a multimedia player, wherein said set top box comprising:
a casing;
a first interface, coupled to said multimedia player;
a network transmission interface, coupled to said first interface and an external network, for receiving at least one network audio/video data and sending at least one said network audio/video data to said multimedia player; and
a control unit, disposed on a surface of said casing and coupled to said first interface, for controlling each component in said set top box; and
said multimedia player comprising:
a casing;
a second interface, coupled to said first interface; and
a multimedia processing unit, coupled to said second interface, for decoding at least one of said network audio/video data and outputting at least one video signal or audio signal.

12. The set top box system of claim 11, wherein said set top box further comprises a data transmission interface coupled to said first interface and an external device, for receiving at least one first audio/video signal from said external device and sending at least one of said first audio/video signals to said multimedia player.

13. The set top box system of claim 11, wherein said set top box further comprises an input unit, installed on a surface of said casing and coupled to said control unit, such that after said input unit is triggered to produce an execution instruction, said execution instruction is sent said control unit, and then sent from said control unit to said multimedia processing unit through said first interface.

14. The set top box system of claim 11, wherein said multimedia processing unit further comprises a demultiplexer, a reduced instruction computing unit, a video processing device, and an audio processing unit, and said demultiplexer converts at least one of said network audio/video data into at least one second audio/video signal; and at least one of said second audio/video signals is decoded and processed by said reduced instruction set computing unit, said video processing device and said audio processing unit, and then converted into at least one video signal and at least one audio signal.

15. The set top box system of claim 14, wherein said multimedia player further comprises:
a video output terminal, installed on said casing, and coupled to said multimedia processing unit, for outputting at least one of said video signal to a display device;
a multi-channel decoding unit, coupled to said multimedia processing unit, for converting at least one of said audio signals to at least one of said analog audio signals through said multi-channel decoding unit; and
an audio output terminal, installed on said casing, and coupled to said multi-channel decoding unit, for outputting at least one of said analog audio signals to a speaker.

16. The set top box system of claim 15, wherein said multimedia player further comprises:
a storage device, coupled to said multimedia processing unit, for storing at least one of said second audio/video signals, and said multimedia processing unit being provided for reading at least one of said second audio/video signals, and outputting at least one of said second audio/video signals to at least one of said second audio/video signals by said video output terminal and said audio output terminal;
a system memory, coupled to said multimedia processing unit, for storing a startup program to execute the operation of said set top box system; and a buffer, coupled to said multimedia processing unit, for executing said startup program and converting at least one of said network audio/video data into at least one second of said audio/video signals, and said buffer being provided for said multimedia processing unit to read at least one of said second audio/video signal for performing a data decoding.

17. A method for playing Web TV by a set top box system, and said set top box system including a set top box and a multimedia player, and said set top box including a first interface, a network transmission interface, a data transmission interface and a control unit, and said multimedia player including a second interface and a multimedia processing unit; and said first interface being coupled to said second interface, and said method for playing said Web TV set top box system comprising the steps of:
transmitting at least one network audio/video data from an external network or at least one first audio/video signal from said multimedia player from said set top box to said multimedia processing unit when said first interface is coupled to said second interface;
converting at least one of said network audio/video data into at least one of said second audio/video signals; and
outputting at least one of said first audio/video signals or at least one of said second audio/video signal.

18. The method of claim 17, further comprising the steps of:
executing a corresponding function program according to an execution instruction issued by an input unit; and
receiving at least one of said network audio/video data or at least one of said first audio/video signals through said network transmission interface or said data transmission interface specified by said function program.

19. The method of claim 17, further comprising the steps of:
converting at least one of said first audio/video signal or at least one of said second audio/video signal into at least one video signal and at least one audio signal;
converting at least one of said audio signals into at least one analog audio signal; and
outputting at least one of said analog audio signals and at least one video signal.

20. The method of claim 17, wherein said function program is a multimedia playing function program, a Web TV function program or a video-recording function program.
